(19) United States
(12) Patent Application Publication
(10) Pub. No.: US 2004/0077451 A1
(43) Pub. Date: Apr. 22, 2004

(54) Full time four - wheel drive differential

(76) Inventor: Jeong-Heon Kam, Gyeonggi-do (KR)

Correspondence Address: MORGAN, LEWIS & BOCKIUS, LLP., 3300 HILLVIEW AVENUE, PALO ALTO, CA, 94304, US

(21) Appl. No.: 10/653,570

(22) Filed: Sep. 2, 2003

(30) Foreign Application Priority Data
Oct. 16, 2002 (KR) 2002-63173

(51) Int. Cl. F16H 48/06

(52) U.S. Cl. 475/233

(57) ABSTRACT

An all-wheel drive differential wherein a pinion, a ring gear of an inner case and a sun gear constitute a center differential for adjusting a speed differential between the front wheels and rear wheels of a vehicle, and helical teeth on the pinion, the ring gear, the sun gear and friction washer function as the differential limitation of the center differential, while a front differential formed with a differential using spider pinions in the inner case function as a differential limitation of the front differential by equipping a clutch pack at the front differential, thereby enabling to construct the all-wheel drive differential in a simple and compact fashion.

### CROSS-REFERENCE TO RELATED APPLICATIONS

This application claims priority of Korean Application No. 10-2002-0063173, filed on Oct. 16, 2002, the disclosures of which are incorporated fully herein by reference.

### FIELD OF THE INVENTION

The present invention relates to a full time four-wheel drive differential for a four-wheel drive vehicle and, more particularly, to a full time four-wheel drive differential designed in a simple and compact structure.

### BACKGROUND OF THE INVENTION

In general, a four-wheel drive (4WD) vehicle drives all four wheels, each wheel having a driving force which is transferred to a road surface to have an all-weather driving performance. These systems have been marketed in two forms according to a power transferring method, that is, a part time four-wheel drive (4WD) and a full time 4WD or All Wheel Drive (AWD). A part time 4WD system normally operates in two-wheel drive mode. Under rugged road or adverse weather conditions, the system engages to four-wheel drive mode in which an exclusive separate four-wheel transfer is utilized to engage the system to four-wheel drive mode for applying more force to the ground.

A system generally termed as AWD has a structure that receives driving force on all four wheels at all times, and can be operable in normal times and in bad weather conditions as well. The AWD system is typically equipped on luxury vehicles for safety purposes.

However, an AWD system is structurally complex because a four-wheel differential used for the AWD must simultaneously transmit power from the transmission to the front wheels and rear wheels and perform a differential operation for adjusting the rotating speed difference therebetween, while performing a function of differential restriction for escaping from a rugged terrain.

In other words, a transaxle and a transfer case should be equipped therein with two differential gears of a front differential and a center differential, and these two differential gears should also be mounted with a differential limitation device.

### SUMMARY OF THE PRESENT INVENTION

Embodiments of the present invention provide a full time four-wheel drive differential constructed in a simple and compact fashion and configured to simultaneously perform the functions of a center differential for operation of the front and rear wheels, a front differential for the front left and right wheels, differential limitation between the front and rear wheels, and differential limitation between the front left and right wheels.

In accordance with an embodiment of the present invention, an AWD differential comprises an outer case that rotates by a turning effect provided from a transmission and disposed with a plurality of pockets along a circumferential direction of a rotating axis. A plurality of pinions, each having helical teeth, are inserted into the plural pockets in order to maintain a rotating axis parallel to that of the outer case. A sun gear is meshed with an inner side of the pinions for transmitting power to the rear wheels. An inner case is equipped with a ring gear meshed with the outside of the pinions and is rotatably mounted with an inner side of the outer case. Spider pinions are mounted within the inner case via a spider pinion shaft. Left and right side gears are meshed with the spider pinions, and a clutch pack is interposed between the left and right side gears and the inner case.

In an alternative embodiment, a differential according to the invention includes an outer case with first and second differential means and limiting means disposed therein. The first differential means adjusts for a speed differential between the front and rear wheels. The second differential means adjusts for a speed differential between one pair of driven wheels of the vehicle. Preferably, this pair of driven wheels is the front wheels. The limiting means limits the speed differential between the wheels.

In a preferred embodiment, the first differential means comprises an inner housing, a plurality of pinions and a sun gear. The inner housing is within the outer case and defines a ring gear. The pinions cooperate with the ring gear and the sun gear is disposed within the pinions and cooperates therewith. More preferably, the second differential means comprises a spider pinion and left and right side gears. The spider pinion is mounted on a spider pinion shaft within the inner housing. The left and right side gears mesh with the spider pinion. The limiting means also preferably includes at least one clutch pack disposed between the side gears and the inner housing and friction washers disposed between the pinions and sun gear and the inner housing and outer case.

### BRIEF DESCRIPTION OF THE DRAWINGS

For fuller understanding of the nature and objects of the present invention, reference should be made to the following detailed description taken in conjunction with the accompanying drawings in which:

FIG. 1 is a schematic drawing illustrating a structure of an AWD differential according to an embodiment of the present invention;

FIG. 2 is a schematic drawing illustrating a state where the AWD differential of FIG. 1 is applied; and

FIG. 3 is a schematic drawing illustrating a differential limitation operation of the AWD differential of FIG. 1.

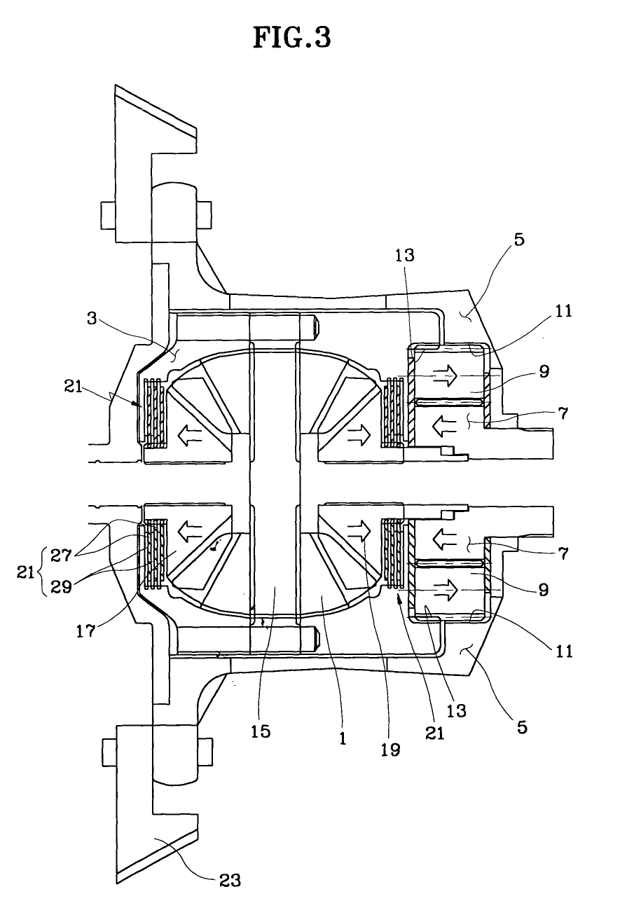

### DETAILED DESCRIPTION OF THE INVENTION

Hereinafter, an embodiment of the present invention will be described in detail with reference to the accompanying drawings.

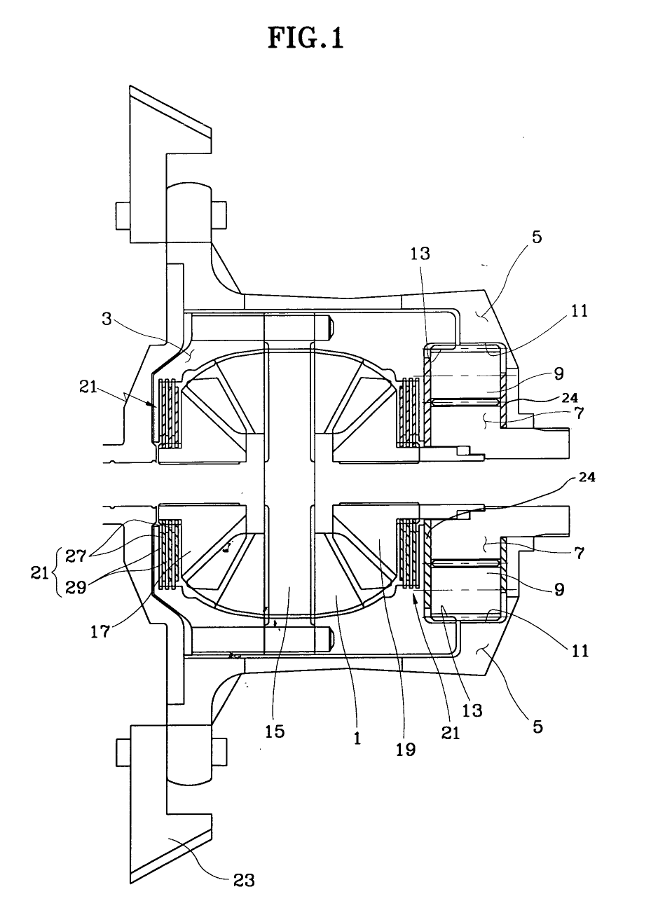

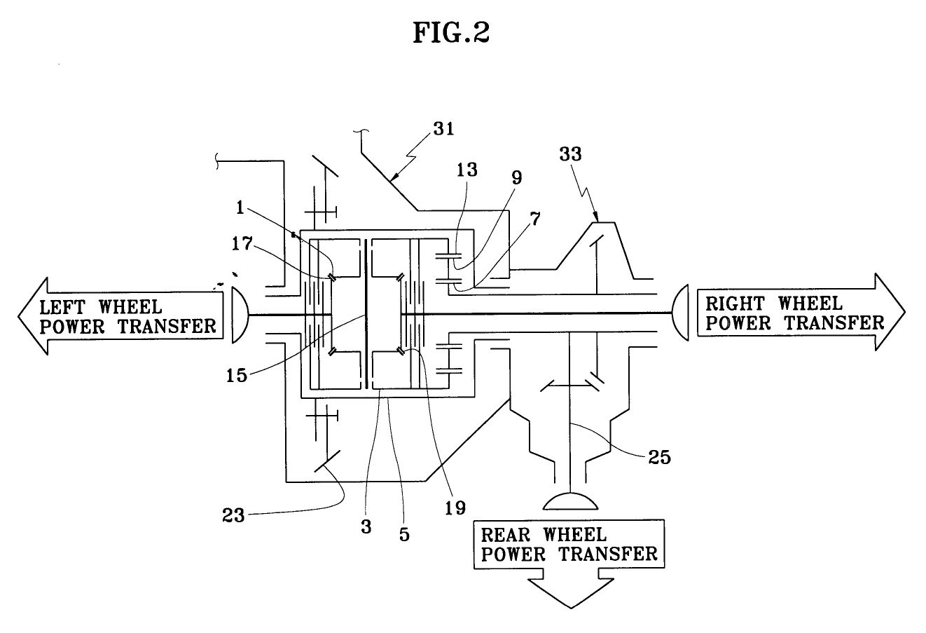

As shown in FIGS. 1 and 2, an outer case 5 encompasses an inner case 3 equipped with a differential that uses a conventional spider pinion 1 and pinions 9 interposed between the inner case 3 and a sun gear 7 in order to perform a differential operation by distributing the rotational force from the outer case 5 to the inner case 3 and the sun gear 7. Thus, an AWD differential according to an embodiment of the invention comprises the outer case 5 rotated by the transmission and disposed with a plurality of pockets 11 along a circumferential direction of a rotating axis. The plurality of pinions 9 each have helical teeth inserted into the plural pockets 11 in order to maintain the axis of rotation parallel to that of the outer case 5. The sun gear 7 meshes with an inner side of the pinions 9 for transmitting power to the rear wheels. The inner case 3 is equipped with a ring gear 13 that meshes with the outside of the pinions 9 and is rotatably mounted with an inner side of the outer case 5. Spider pinions 1 are mounted within the inner case 3 via a spider pinion shaft 15. Left/right side gears 17 and 19 mesh with the spider pinions 1. A clutch pack 21 is interposed between the left/right side gears 17 and 19 and the inner case 3.

The outer case 5 carries a driven gear 23 for receiving the rotational force from the transmission and the like. The sun gear 7 and the ring gear 13, engaged with the plurality of pinions 9, are formed as helical gears.

The pinions 9 function to transmit the rotational force from the outer case to the sun gear 7 and the ring gear 13 and simultaneously act to perform a differential operation for the sun gear 7 and the ring gear 13. The pinions 9 are, however, meshed with the sun gear 7 and the ring gear 13 in a helical tooth-like shape such that when there is a difference in the rotating speed therebetween, the pinions 9 receive a thrust force and friction on the tooth-like portion thereof, enabling performance of the differential limitation function.

In a preferred embodiment embodiment, in order to supplement the differential limitation function generated by friction on the tooth-like surface of the pinion 9, friction washers 24 are respectively interposed in spaces where the pinions 9 and the sun gear 7 face the inner case 3, and where the pinions 9 and the sun gear 7 face the outer case 5. The differential limitation function is enhanced by the friction at the friction washers 23 generated by the thrust force received by the pinions 9.

The sun gear 7, as illustrated in FIG. 2, is connected to a shaft 25 to transmit power to the rear wheels.

The clutch pack 21, as in a conventional differential limitation device, includes a plurality of friction discs 27 disposed at left/right side gears 17 and 19, and a plurality of plates 29 disposed at the inner case 3 alternating with the friction discs 27. As a result, thrust force generated from the tooth-like surfaces of the spider pinions 1 and the left/right side gears 17 and 19 acts on the clutch pack 21.

In summary, in a preferred embodiment of the present invention, the pinions 9, ring gear 13 at the inner case 3 and sun gear 7 constitute a center differential for adjusting a speed differential between the front wheels and the rear wheels. The helical gears on the pinions 9, the ring gear 13, the sun gear 7 and the friction washer 23 function as the differential limitation of the center differential. Additionally, a differential using the spider pinions 1 disposed inside the inner case 3 constitutes a front differential, and the clutch pack 21 mounted at the front differential is used as a differential limitation device of the front differential.

Hereinafter, the operation of an embodiment of the present invention as explained above will be described.

The rotational force applied to the outer case 5 is transmitted to the sun gear 7 and the ring gear 13 via the pinions 9 while the vehicle is moving forward when there is no speed difference between the front wheels and the rear wheels. Under these conditions, the sun gear 7, the ring gear 13 and the pinions 9 rotate integrally as one unit. All other internally constituting elements within the inner case 3 also rotate as one unit as the vehicle is in forward motion.

However, when a rotational speed difference occurs between the front wheels and rear wheels, the pinions 9 rotate on their own axis to act as a differential. Under such conditions the pinions 9, the ring gear 13 and the sun gear 7 create a thrust force as they are all inter-engaged and friction is generated from the tooth-like surfaces of the engaged gears. The thrust force acts on friction washers 24 to perform a differential limitation function along with the friction from the tooth-like surfaces of the gears.

When rotational speed difference occurs between the front wheels, the spider pinions 1 supported by the spider pinion shaft 15 rotate on their own axis to act as a differential. Friction generated from the clutch pack 21 disposed between the left/right side gears 17 and 19 and the inner case 3 performs the differential limitation function of the front differential.

As described above and with reference to FIG. 2, the AWD differential according to an embodiment of the present invention is composed of a compact structure including all constitutional elements within the transaxle 31 while the transfer case 33 has only connecting parts to the propeller shaft 25.

As apparent from the foregoing, there is an advantage in the AWD differential thus described according to the present invention in that a pinion, a ring gear of an inner case and a sun gear constitute a center differential for adjusting a speed differential between the front wheels and rear wheels, and the helical teeth on the pinion, the ring gear and the sun gear and friction washer function as the differential limitation of the center differential, while a front differential formed with a differential using spider pinions in the inner case function as differential limitation of the front differential by equipping a clutch pack at the front differential, thereby enabling to construct the AWD differential in a simple and compact fashion.

What is claimed is:

1. An all wheel drive (AWD) differential, the AWD differential comprising:
an outer case rotated by a rotational force from a transmission and disposed with a plurality of pockets along circumferential direction of a rotating axis;
a plurality of pinions each having helical teeth inserted into plural pockets in order to maintain a rotating axis parallel to that of said outer case;
a sun gear meshed with an inner side of said plurality of pinions for transmitting power to the rear wheels of a vehicle;
an inner case equipped with a ring gear meshed with an outside of said plurality of pinions and rotatably mounted with an inner side of said outer case;
spider pinions mounted within said inner case via a spider pinion shaft;
left and right side gears meshed with said spider pinions; and
a clutch pack interposed between said left and right side gears and said inner case.

2. The AWD differential as defined in claim 1, wherein friction washers are respectively interposed in spaces where said pinions and said sun gear face said inner case, and where said pinions and said sun gear face said outer case.

3. The AWD differential as defined in claim 1, wherein said clutch pack comprises:
a plurality of friction discs disposed at said left and right side gears; and
a plurality of plates disposed at said inner case alternating with said friction discs.

4. An all wheel drive differential, comprising:
an outer case;
first differential means disposed in said case for adjusting a speed differential between front and rear wheels of a vehicle;
second differential means disposed in said case for adjusting a speed differential between one pair of driven wheels of the vehicle; and
limiting means disposed in said case for limiting the speed differential between wheels.

5. The differential of claim 4, wherein said first differential means comprises:
an inner housing within the outer case, said inner housing defining a ring gear;
a plurality of pinions cooperating with said ring gear; and
a sun gear disposed within said pinions and cooperating therewith.

6. The differential of claim 5, wherein said second differential means comprises:
a spider pinion shaft mounted within the inner housing;
spider pinions mounted on said shaft; and
left and right side gears meshing with said spider pinions.

7. The differential of claim 6, wherein said limiting means comprises:
at least one clutch pack disposed between said side gears and said inner housing; and
friction washers disposed between said pinions and sun gear and the inner housing and between said pinions and sun gear and the outer case.
